(19) United States
(12) Patent Application Publication
(10) Pub. No.: US 2016/0138940 A1
(43) Pub. Date: May 19, 2016

(54) CONTACTLESS ROTARY SENSOR

(71) Applicant: BorgWarner Inc., Auburn Hills, MI (US)

(72) Inventors: Christopher V. Kurmaniak, Clarkston, MI (US); Larry A. Pritchard, Macomb, MI (US); Thad Kopp, Oakland Township, MI (US)

(21) Appl. No.: 14/935,732

(22) Filed: Nov. 9, 2015

Related U.S. Application Data
(60) Provisional application No. 62/081,721, filed on Nov. 19, 2014.

(51) Int. Cl. G01D 5/14

(52) U.S. Cl. CPC G01D 5/145

(57) ABSTRACT

A rotary sensor (10) includes a rotating portion (12) having an outside surface (28) and a magnetic pattern (16) magnetically printed on the rotating portion (12). One or more hall-effect switches (32) are located adjacent to the magnetic pattern (16) and a magnetic field of at least a portion of the magnetic pattern actuates the switches (32). Rotation of a driveshaft (18) controls electric signals conducted through the switches (32) indicating the angular position of the driveshaft (18).

### PRIORITY CLAIM

This application claims the benefit of U.S. Provisional Application No. 62/081,721 filed on Nov. 19, 2014 the entire contents of which are hereby incorporated by reference.

### TECHNICAL FIELD

The present application relates to electronic sensors and, more particularly, to electronic sensors detecting rotary position without contacting a rotating member.

### BACKGROUND

Regardless of the exact engine type or drivetrain used to power a vehicle, the engine generally uses a number of rotating members to transfer power to the wheels of the vehicle or control functions of the vehicle. The vehicle can have a plurality of rotating members or driveshafts the angular position of which can be monitored using rotary sensors. The driveshaft can include a rotary disk having electrically-conductive points placed at angularly-spaced locations along the disk. The points are also located at different distances as measured from the center of the disk. An electronic sensor can deploy sliding electrically-conductive contacts that touch the disk. As the disk rotates, the sliding contacts can periodically touch the electrically-conductive points at which time a circuit is closed and an electrical signal is communicated through the connection between a sliding contact and conductive point. The electrical signal can indicate that the driveshaft is in a particular angular position.

Sensing driveshaft position using electrically-conductive points and sliding contacts can be challenging. For instance, vehicles subject driveshafts to harsh environments that include vibrations and moisture as well as significant temperature and humidity fluctuations. These environments can cause disruptions between the points and the sliding contacts and cause sensors using such an arrangement to provide inaccurate data or fail. Moreover, electric sensors that use conductive points and sliding contacts can be capital and/or labor intensive to produce.

### SUMMARY

In one embodiment, a rotary sensor includes: a rotating portion having a magnetic pattern magnetically printed on the rotating portion; and one or more hall-effect switches located adjacent to the magnetic pattern. A magnetic field of at least a portion of the magnetic pattern actuates the switches and rotation of a driveshaft controls electric signals conducted through the switches indicating the angular position of the driveshaft.

In another embodiment, a rotary sensor includes: a rotating portion having a magnetic pattern magnetically printed on the rotating portion; one or more arcuate areas divided into a plurality of magnetized units having individual polarities; and one or more hall-effect switches located adjacent to the magnetic pattern. A magnetic field of at least one of the magnetized units actuates at least one of the switches and rotation of a driveshaft controls electric signals through the switches indicating the angular position of the driveshaft.

### BRIEF DESCRIPTION OF THE DRAWINGS

FIG. 1 depicts a perspective view of an embodiment of a rotating portion of a rotary sensor as it is attached to a driveshaft;

FIG. 2 depicts a perspective view of an embodiment of a sensing portion of a rotary sensor;

FIG. 3 depicts a perspective view of an embodiment of a rotary sensor including a rotating portion and a sensing portion; and

FIG. 4 depicts a perspective view of an embodiment of a rotating portion including a magnified view of an arcuate area that is subdivided into magnetic portions.

### DETAILED DESCRIPTION

A contactless rotary sensor includes a rotating portion or disk into which a magnetic surface or pattern in imprinted. The magnetic pattern can be used in conjunction with a plurality of hall-effect switches that are positioned proximate to the rotating disk and detect the angular position of a driveshaft in a vehicle. As the driveshaft rotates, the disk rotates as well and portions of the magnetic pattern can pass one or more hall-effect switches thereby changing the state of the switch based on the angular position of the driveshaft. The hall-effect switches can be electrically linked with a microprocessor that receives electrical signals from the switches and can determine when each switch is in an open or closed state. Based on the combined states of the hall-effect switches, the microprocessor can determine the angular position of the driveshaft. Moreover, the magnetic pattern imprinted in the rotating disk can provide sharp distinctions at locations on the rotating disk where polarity changes. That is, the existence of magnetic force can be controlled by a very small amount of angular movement, such as two degrees or less of driveshaft rotation. The sharp transitions between existence and absence of magnetic flux or force from the magnetic pattern can help provide more accurate detection of small amounts of angular driveshaft rotation. The precise location of an angular marker can be observable by a binary/switch type sensor.

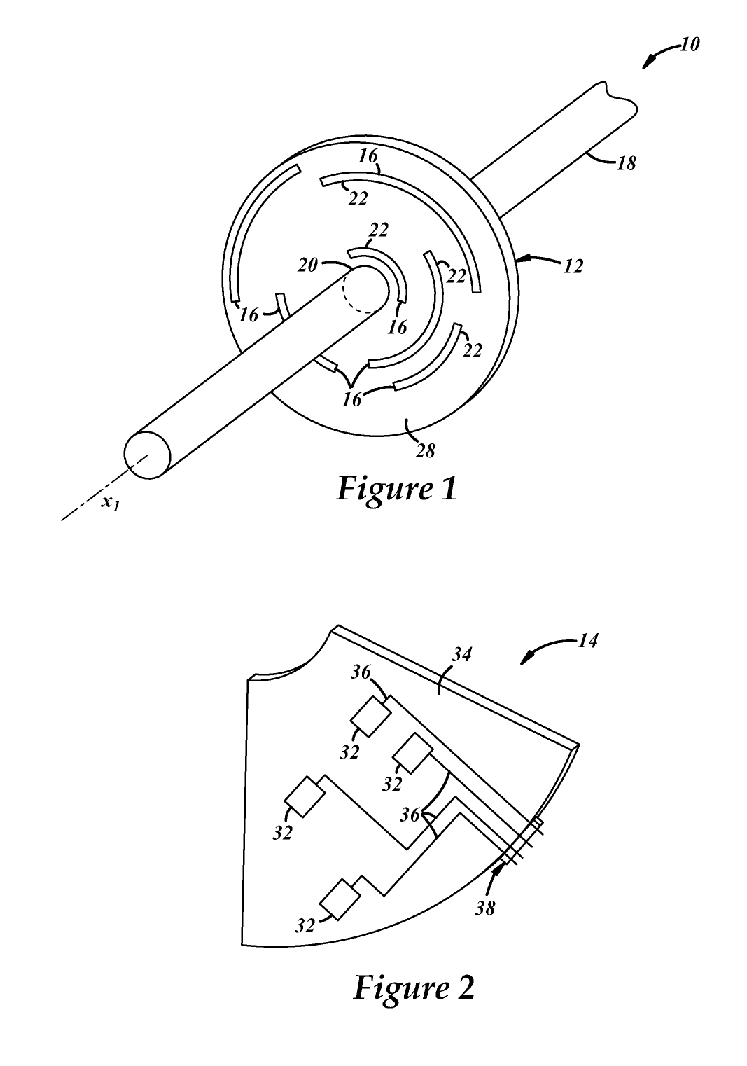

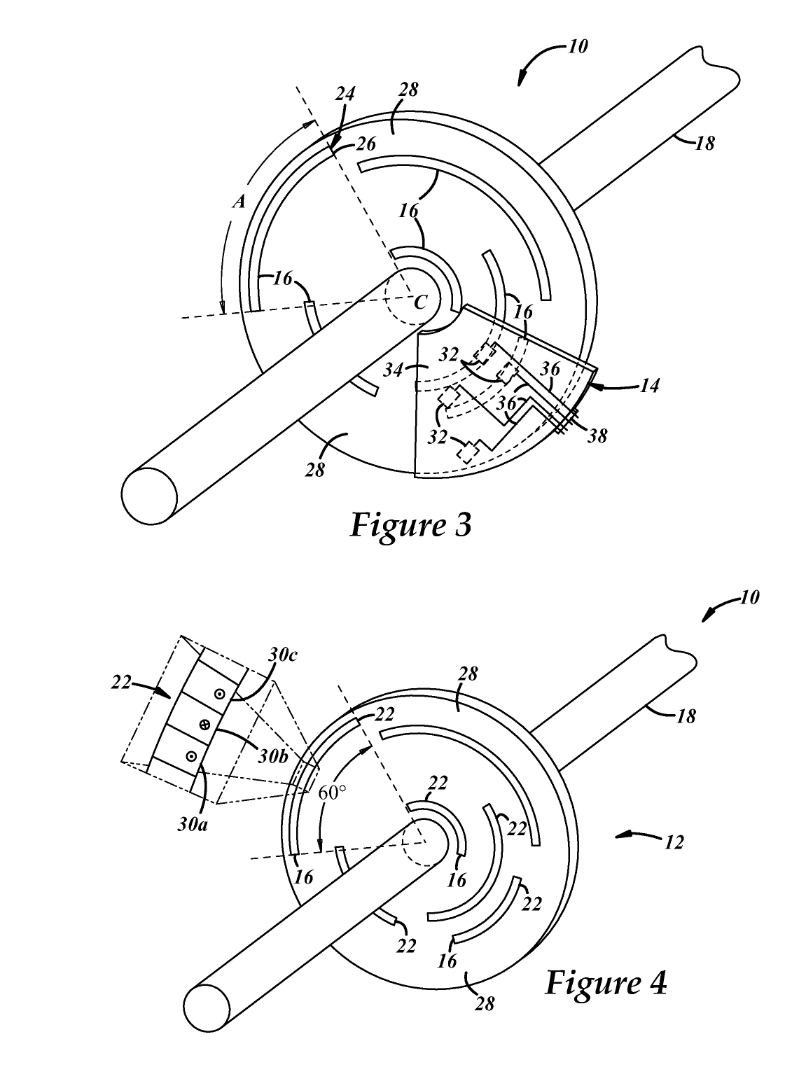

The FIGS. 1-4 illustrate embodiments of a rotary sensor 10 that include a rotating portion 12, such as a rotating disk, and a sensing portion 14. The rotating portion 12 (also referred to as a rotating disk) includes a magnetic pattern 16 that is imprinted on the rotating portion 12 using magnetic printing techniques. The rotating portion 12 can be fixedly attached to a driveshaft 18 so that the portion 12 and driveshaft 18 rotate together and that no angular motion occurs between the rotating portion 12 and the driveshaft 18. The driveshaft 18 can be implemented using a wide variety of rotating members that transmit rotational force. For instance, vehicles use rotating members or driveshafts to transmit power from an engine to the wheels of the vehicle. However, driveshafts can also be used to control different vehicle functions, such as engaging or disengaging portions of a vehicle drivetrain so that a user can switch between two-wheel-drive and four-wheel-drive modes. In one implementation, the driveshaft 18 can actuate a transfer case the rotation of which can engage or disengage four-wheel-drive operation of a vehicle.

In the embodiment shown, the rotating portion 12 has a substantially circular cross-sectional shape when viewed from the axis of driveshaft rotation xi and also includes a driveshaft opening 20 through which the driveshaft 18 can extend. To create the magnetic pattern 16, the rotating portion 12 can be made exclusively from a magnetizable material, such as a permanent magnet. In one implementation, the rotating portion 12 can comprise a Neodymium (NdFeB) magnet that is known to those skilled in the art. However, it should be appreciated that other types of magnetizable materials could be used, including but not limited to ferromagnets. The magnetic pattern 16 comprises one or more magnetic arcuate areas 22 the shape and area of which collectively indicate the angular position of the driveshaft 18. The diameter of the rotating portion 12 can be determined based on the number of magnetic arcuate areas 22 included in each magnetic pattern 16 and/or the depth of those areas 22.

Before use in the rotary sensor 10, the rotating portion 12 can be imprinted with the magnetic pattern 16 using a magnetic printer. Magnetic printers (not shown) selectively impart a desired magnetic field on the surface area of a magnetizable material that is bounded by defined arcuate areas 22 of the rotating portion 12. The magnetic pattern 16 can be made up of a plurality of magnetic arcuate areas 22 that can have a defined arc length as well as a depth. The arc length A of the arcuate area will be discussed in terms of degrees but could also be described in other forms of angular measurement. The depth of the arcuate area 22 can be measured using an outer radius 24 measured from the furthest point of the arcuate area to the center C of the rotating portion 12 and an inner radius 26 measured from the nearest point of the arcuate area to the center C of the rotating portion 12. The measured inner radius can be subtracted from the measured outer radius to determine the depth of the arcuate area.

Each arcuate area 22 may be imparted with a magnetic field. For example, an arcuate area 22 can extend over an arc of 60° and have a magnetic flux flowing from a north (N) pole to a south (S) pole a magnetic field strength of >600 gauss (G). This direction of flux can be referred to as a magnetic force directed normal to the surface 28 and toward the sensing portion 14. However, the arcuate areas 22 can also have a magnetic field in the opposite direction such that the area 22 has a magnetic force directed normal to the surface 28 and away from the sensing portion 14. Arcuate areas 22 can also be subdivided along their arc length A into two or more magnetized units 30. In an embodiment, an arcuate area 22 can extend over an arc of 60° but also be subdivided into sixty different magnetized units 30. This is shown in more detail in FIG. 4. Adjacent magnetized units 30 can have different flux direction. That is, the flux of a first magnetized unit 30a can flow toward a sensing portion 14 and have a magnetic field strength of over 600 G while a second magnetized unit 30b can flow away from the sensing portion and have the same magnetic field strength (>600 G) in an opposite direction. The relative flux direction of the magnetized units 30a-30c are shown with a dot indicating flux flowing toward the sensing portion 14 and an x indicating flow away from the sensing portion. A third magnetized unit 30c can then have flux flowing toward the sensing portion 14 like the first magnetized unit 30a and have the same magnetic field strength. As the driveshaft rotates, the changes in flux direction of each arcuate area 22 and/or magnetized unit 30 can be sensed using switches 32 placed proximate the surface 28 of the rotatable portion 12. Generally speaking, the magnetic field strength of the arcuate area 22 or magnetized units 30 is significantly stronger than the force required to actuate a switch 32. The significantly stronger magnetic field can provide a sharp change in switch state. This will be discussed below in more detail.

To generate the magnetic pattern 16, a magnetizing print head can be placed in close proximity to a surface 28 of the rotating portion 12 on which the magnetic pattern 16 will be created. The magnetizing print head (not shown) can include a high-voltage inductor that creates a magnetic field in the desired arcuate area 22 of the surface 28. After placing the magnetizing print head adjacent to a portion of the surface 28 to be magnetized, a desired voltage level can be generated in a capacitive device and then discharged into the inductor of the magnetizing head. The discharge of energy from the capacitive device through the inductor can magnetize the surface 28 adjacent to the magnetizing print head along with the entire depth of material under the surface such that the surface 28 is one pole (e.g., north) while on an opposite side of that surface exhibits an opposite pole (e.g., south). The magnetizing print head can then be moved to the next area of the surface 28 to be magnetized and the application of voltage to the capacitive device and inductor repeats until all of the surface 28 is magnetized according to the shape and area of the magnetic pattern 16. The relative strength of the magnetic field imparted in a particular area of the surface 28 can be adjusted upward or downward in relation to upward or downward application of voltage delivered to the magnetizing print head. Different implementations of magnetic print heads could be used to implement the magnetic pattern 16 that is created in the rotating portion 12 as will be appreciated by those skilled in the art. It should be appreciated that the magnetic pattern 16 can include one or more magnetic arcuate areas 22 that are created on the surface 28 perpendicular to the axis of driveshaft rotation xi.

The sensing portion 14 of the rotary sensor 10 can be placed in relatively close proximity to the magnetic pattern 16 imprinted on the rotating portion 12. One or more sensing switches 32 can be attached to a printed circuit board (PCB) 34 and each of which can be connected to electrical pathways 36 leading to an electrical output 38. The sensing switches 32 can be hall-effect switches that are biased in an open or non-conductive position. As the driveshaft 18 rotates, arcuate areas 22 of the of the magnetic pattern 16 can pass close enough to the switches 32 that the magnetic field of the arcuate area 22 or magnetized unit 30 exerts force on the switch 32 to overcome the bias placing the switch 32 in a open or non-conductive position thereby closing the switch 32. To ensure reliable closing of the switch 32 as an arcuate area 22 passes as well as opening of the switch 32 after the area 22 has passed, the distance between the magnetic pattern 16 and the switch 32 may vary depending on a number of factors, such as strength of the magnetic field and force needed to overcome the bias of the switch 32.

In one implementation, the magnetic field strength of the arcuate area 22 is >600 G and the surface 28 of the rotating portion 12 is located less than 0.2 millimeters (mm) from the switch 32. As driveshaft 18 rotates, a plurality of switches 32 can open and close thereby creating a changing digital address in response to changes in angular position of the driveshaft 18. Changes in the digital address can indicate changes in angular position. In one implementation, the switches 32 selectively transmit electrical signals indicating an angular position of the driveshaft 18 based on changes in a bit pattern of a particular length—also known as gray code. In this example, a four bit word is used but other bit lengths are possible. One example of the switches 32 is an Allegra Microsystems 1250 hall switch. The change in bit pattern in response to the angular movement of the magnetic pattern 16 by the driveshaft 18 can indicate to a microprocessor (not shown) the angular position of the driveshaft 18. Various computing hardware such as the microprocessor can be used in conjunction with the rotary sensor 10 to receive the electrical signals transmitted through the switches. The microprocessor can be any type of device capable of processing electronic instructions including microprocessors, microcontrollers, host processors, controllers, vehicle communication processors, and application specific integrated circuits (ASICs). It can be a dedicated processor used only for the rotary sensor 10 or can be shared with other vehicle systems. The microprocessor can execute various types of digitally-stored instructions, such as software or firmware programs stored in a memory device.

The foregoing description is considered illustrative only. The terminology that is used is intended to be in the nature of words of description rather than of limitation. Many modifications and variations will readily occur to those skilled in the art in view of the description. Thus, the foregoing description is not intended to limit the invention to the embodiments described above. Accordingly the scope of the invention as defined by the appended claims.

What is claimed is:

1. A rotary sensor (10), comprising:
a rotating portion (12) having a magnetic pattern (16) magnetically printed on the rotating portion (12);
one or more hall-effect switches (32) located adjacent to the magnetic pattern (16), wherein a magnetic field of at least a portion of the magnetic pattern actuates the switches (32) and rotation of a driveshaft (18) controls electric signals conducted through the switches (32) indicating the angular position of the driveshaft (18).

2. The rotary sensor (10) of claim 1, wherein the magnetic pattern further comprises one or more arcuate areas (22) that are divided into magnetic portions (30).

3. The rotary sensor (10) of claim 1, wherein the rotating portion (12) further comprises a Neodymium magnet.

4. The rotary sensor (10) of claim 1, further comprising a driveshaft opening (20) for receiving a driveshaft (18).

5. The rotary sensor (10) of claim 1, wherein a distance between the rotating portion (12) and the switches (32) is less than 0.2 millimeters (mm).

6. The rotary sensor (10) of claim 1, wherein the hall-effect switches (32) are coupled to a printed circuit board (PCB).

7. A rotary sensor (10), comprising:
a rotating portion (12) having a magnetic pattern (16) magnetically printed on the rotating portion (12);
one or more arcuate areas (22) that are divided into a plurality of magnetized units (30) having individual polarities;
one or more hall-effect switches (32) located adjacent to the magnetic pattern (16), wherein a magnetic field of at least one of the magnetized units (30) actuates at least one of the switches (32) and rotation of a driveshaft (18) controls electric signals through the switches (32) indicating the angular position of the driveshaft (18).

8. The rotary sensor (10) of claim 7, wherein the rotating portion (12) further comprises a Neodymium magnet.

9. The rotary sensor (10) of claim 7, further comprising a driveshaft opening (20) for receiving a driveshaft (18).

10. The rotary sensor (10) of claim 7, wherein a distance between the rotating portion (12) and the switches (32) is less than 0.2 millimeters (mm).

11. The rotary sensor (10) of claim 7, wherein the hall-effect switches (32) are coupled to a printed circuit board (PCB).
